(19) United States
(12) Patent Application Publication
(10) Pub. No.: US 2011/0110247 A1
(43) Pub. Date: May 12, 2011

(54) Routing Node and Terminal for an FDD Communication Network and Method for Operating Them

(76) Inventors: Ruediger Halfmann, Otterberg (DE); Thomas Haustein, Potsdam (DE); Andreas Ibing, Berlin (DE); Wolfgang Zirwas, Munchen (DE)

(21) Appl. No.: 12/863,231

(22) PCT Filed: Jan. 15, 2009
(86) PCT No.: PCT/EP09/50455

§ 371 Date: Aug. 16, 2010

(30) Foreign Application Priority Data
Jan. 16, 2008 (DE) 10 2008 004 690.6

(51) Int. Cl. H04J 1/00; H04L 12/26

(52) U.S. Cl. 370/252; 370/281

(57) ABSTRACT

One exemplary aspect of the invention provides a routing node for an FDD communication network, which node has a node receiving apparatus, which is set up in such a manner that it can be used to receive signals from a terminal at a first frequency, and a node transmitting apparatus which is set up in such a manner that it can be used to transmit signals to the terminal at a second frequency. In this case, the routing node is set up in such a manner that it can transmit an indication signal to the terminal, which signal indicates whether the routing node can receive signals at the first frequency at a given point in time.

### FIELD OF THE INVENTION

The invention relates to a forwarding node and a terminal for an FDD communication network. In addition, the invention relates to a method for the operation of a forwarding node and of a terminal in an FDD communication network. Furthermore, the invention relates to a program element and a computer-readable medium.

### PRIOR ART

The use of what are known as multihop forwarding nodes is envisaged for mobile radio networks such as 3GPP LTE (Long Time Evolution), which is currently pending standardization. Such multihop forwarding nodes provide a means for achieving the necessary coverage for system extensions without the high costs for a fixed network connection accruing for each access node. Furthermore, the forwarding by means of the forwarding nodes results in a capacity increase for the network, i.e. it is possible to maintain more connections within the network by virtue of an improved signal-to-noise ratio (SNR) being attainable.

However, the use of multihop forwarding nodes entails the problem, particularly in the case of what is known as the Frequency Division Duplex (FDD) mode, that it is necessary for the multihop forwarding nodes to be able to send and receive in both frequency bands, in contrast to base stations and terminals in the network. In other words, the multihop forwarding nodes behave as base stations in one communication direction and as terminals in the opposite direction. Since it is not possible for the multihop forwarding node to send and receive on the same frequency band simultaneously, however, problems may arise for the communication by means of such a multihop forwarding node.

### SUMMARY OF THE INVENTION

It may therefore be necessary to provide a forwarding node and a terminal which provide improved communication in an FDD communication network.

This need may be met by a forwarding node, by a terminal, by a method for the operation of a forwarding node, by a method for the operation of a terminal, by a computer program element and by a computer-readable medium according to the independent patent claims. Further refinements are specified in the dependent claims.

In line with one exemplary aspect of the invention, a forwarding node for an FDD communication network is provided which has a node reception apparatus, which is set up such that it can be used to receive signals from a terminal on a first frequency, and a node transmission apparatus, which is set up such that it can be used to send signals on a second frequency to the terminal. In this case, the forwarding node is set up such that it can send an indicator signal to the terminal which indicates whether the forwarding node can receive signals at a given time on the first frequency. In particular, the forwarding node may be what is known as a multihop forwarding node. By way of example, the indicator signal may be sent to the terminal on the second frequency, but alternatively it may also be sent on a third frequency. In particular, the indicator signal may be produced in a production apparatus of the forwarding node.

In line with another exemplary aspect of the invention, a terminal for an FDD communication network is provided, wherein the terminal has a terminal reception apparatus, which is set up such that it can be used to receive signals from a forwarding node on a second frequency, and a terminal transmission apparatus, which is set up such that it can be used to send signals on a first frequency to the forwarding node. In addition, the terminal has a control unit and is set up such that it can receive an indicator signal from the forwarding node. The control unit is set up such that it controls a time for the sending of a request signal to the forwarding node on the basis of the indicator signal. In particular, such a request signal may be what is known as an NACK signal or what is known as an NACK message, for example.

In line with another exemplary aspect of the invention, a method for the operation of a forwarding node for an FDD communication network is provided, wherein the method involves determining whether the forwarding node is in a terminal mode or a base station mode, and sending an indicator signal to a terminal, wherein the indicator signal is indicative of the determined mode.

In line with another exemplary aspect of the invention, a method for the operation of a terminal for an FDD communication network is provided, wherein the method involves receiving an indicator signal in the terminal, wherein the indicator signal indicates the mode which the forwarding node is in, and deciding when a request signal is sent to the forwarding node, wherein the decision takes account of the indicator signal. In particular, the indicator signal may indicate whether the forwarding node is currently in a base station mode or a reception appliance mode and/or whether the forwarding node is currently ready to receive or ready to send.

In line with another exemplary aspect of the invention, a program element is provided which is set up such that, when executed on a processor, it controls a method according to an exemplary aspect of the invention.

In line with another exemplary aspect of the invention, a computer-readable medium is provided which stores a computer program, wherein the computer program is set up such that, when executed on a processor, it controls a method according to an exemplary aspect of the invention.

In line with the invention, a communication network may also be provided which has at least one base station, at least one forwarding node according to an aspect of the invention and at least one terminal according to an aspect of the invention.

A forwarding node according to an exemplary aspect of the invention may be able to be used to provide a forwarding node which can signal to a terminal whether it is ready for transmission with said terminal. In particular, it may be possible to signal to the terminal whether it is ready for the reception of what is known as an Acknowledge (ACK) signal or Not Acknowledge signal. In communications which are based on a synchronous H-ARQ (Hybrid Automatic Repeat reQuest) retransmission protocol, a terminal uses such signals to transmit in the uplink communication, for example in the case of an LTE uplink, whether transmission of a signal has taken place without error and/or correctly or whether a synchronous repeat (retransmission) needs to be performed. In the case of such synchronous H-ARQ retransmission protocols, this means that at least implicitly H-ARQ process numbers are derived from time information in order to perform a retransmission. A forwarding node according to an exemplary aspect of the invention may be able to be used to extend this determination to the forwarding node, which may be advantageous, since the forwarding node may currently be in a mode in which it communicates with a base station, which means that a terminal cannot transmit its synchronous H-ARQ acknowledgement (ACK/NACK) to the forwarding mode at the time.

The use of an indicator signal which is indicative of the mode or state of the forwarding node may also improve the synchronization and channel estimation, i.e. the estimation of how well suited the relevant channel is for transmission and how good its performance is, because this allows notification of whether the forwarding node is currently in a transmission mode or a reception mode, which means that the time intervals in which the forwarding node does not send any reference signals or pilot signals may be known.

It may also be possible to bypass the need to observe fixed switching times between reception mode and transmission mode, which would otherwise result in inflexible signal transmission which causes low communication capacity. It may also thus be possible to ensure that necessary control information reaches an addressee.

In particular, a method according to an exemplary aspect of the invention may also ensure that ACK/NACK signals or messages which are sent on the basis of synchronous H-ARQ protocols at stipulated frame positions in relation to the frame positions of the received signal or data packet do not cause unnecessary delays in the communication. Such unnecessary delays could occur in conventional methods, since it may be that the forwarding node is not currently in reception mode at the time at which the received terminal wishes to send its ACK/NACK message, i.e. at the time which corresponds to the time for an ACK/NACK message as stipulated in the H-ARQ protocol. If such a case is intended to be excluded for all terminals which are involved, this would possibly result in an inflexible distribution of the frames in conventional systems, since this would cause the possibilities of the forwarding node to be restricted. This drawback may be at least reduced in the case of a method according to an exemplary embodiment of the invention, since the transmission of the indicator signal allows a time for the transmission of the ACK/NACK message to be chosen more flexibly.

A fundamental idea of an exemplary aspect of the invention may be that a forwarding node signals to a terminal or mobile station (MS), for example a mobile telephone or a PDA, whether it is in the transmission mode, so that the MS can determine whether the forwarding node can receive a message at the frame position for a synchronous H-ARQ message, e.g. ACK/NACK message. If this should not be possible at this frame position, the H-ARQ message can be delayed by the MS, for example it can be automatically delayed to the subsequent frame, or to the next frame in which the forwarding node is ready to receive. Since the forwarding node knows when it should receive which message or which data packet from the MS, it may be able to calculate the new frame position or the new frame at which it must expect an H-ARQ message from which MS. This may mean that an additional feedback message from the MS becomes superfluous.

Overall, it may be stated that such an FDD forwarding node uses a time-division duplexing method for two modes, wherein the first mode forms communication with the base station (BS) and the second mode forms communication with the mobile station (MS). Hence, the method according to an exemplary aspect of the invention may have explicit or inherent notification of mode changes.

Further exemplary embodiments of the forwarding node are described below. However, the relevant refinements and features also apply to the terminal, the method for the operation of a forwarding node, the method for the operation of a terminal, the computer program element and the computer-readable medium.

In line with an other exemplary embodiment of the forwarding node, the forwarding node is set up such that it may be in a terminal mode or in a base station mode. In addition, the indicator signal indicates the mode which the forwarding node is in. In particular, the forwarding node may be set up such that in the terminal mode it can communicate with the terminal and/or that in the base station mode it can communicate with a base station. That is to say that in the base station mode the forwarding node may be ready to receive signals or data packets which are sent by the BS and may be able to send signals or data packets to the BS. In the terminal mode, on the other hand, it may be ready to receive signals or data packets which are sent by the terminal or by the mobile station and may be able to send signals or data packets to the MS.

In line with another exemplary embodiment of the forwarding node, the forwarding node is set up such that in the terminal mode it can send signals to the terminal on the first frequency and can receive signals from the terminal on the second frequency, and that in the base station mode it can send signals to a base station on the second frequency and can receive signals from the base station on the first frequency.

In line with another exemplary embodiment, the forwarding node also has a synchronization unit which is set up such that it can be used to synchronize the forwarding node to a base station and/or a terminal. In particular, the forwarding node may be set up to receive a synchronization signal from a base station or a terminal. Furthermore, the synchronization unit may also be set up such that it can be used to send a synchronization signal to terminals and/or base stations. In particular, the forwarding node may provide terminals with a synchronization signal constantly, so that they can remain synchronized to the forwarding node. This may allow the forwarding node and the relevant terminals to continue to remain synchronized even when no data packets or messages are received in particular subframes.

Using a synchronization signal, the forwarding node may be subjected to at least one coarse synchronization during or shortly after a switching-on process. Continuous synchronization may be carried out during the operation of the forwarding node by means of pilot signals. Such pilot signals can usually be sent during mobile communication, for example for the purpose of checking the transmission quality.

Further exemplary embodiments of the terminal are described below. However, the relevant refinements and features also apply to the forwarding node, the method for the operation of a forwarding node, the method for the operation of a terminal, the computer program element and the computer-readable medium.

In line with another exemplary embodiment of the terminal, the request signal is an H-ARQ signal, particularly a synchronous H-ARQ signal. In particular, a request signal may also be understood to mean a signal what is known as an ACK/NACK signal, that is to say a signal which the terminal uses to confirm or not to confirm correct reception of a signal and to send a repeat request.

In line with another exemplary embodiment of the terminal, the control unit is set up such that the time determined for the sending of the request signal to the forwarding node is a delayed time. In particular, the delayed time may correspond to a delayed frame or to a later frame.

In summary, an exemplary aspect of the invention may be considered to be that a forwarding node and a terminal are provided, wherein the forwarding node transmits an indicator message which indicates the mode which the forwarding node is currently in. This may correspond to explicit or implicit notification of mode changes. An implementation may have two alternatives.

In a first alternative, which involves as little additional signaling as possible, the FDD structure may be used. The current design for the LTE standard involves the same generic structure being intended to be used for TDD and FDD. This generic structure could then also be used for forwarding by means of forwarding nodes, e.g. what is known as “multihop relaying”.

In a second alternative, an optimized frame structure of TDD needs, such as what are known as turnaround gaps, which occur when changing between reception mode and transmission mode, may be considered. Such gaps are necessary so that a transmitter does not receive its own echo, with a typical duration of such turnaround gaps corresponding to approximately twice what is known as the channel excess delay. In particular, a specific multihop frame structure of this type would require use of specific signals, however.

The exemplary aspects and embodiments explained above, and further exemplary aspects and embodiments, will become more clearly comprehensible to a person skilled in the art by virtue of the exemplary embodiment explained below. In addition, it should be noted that features which have been described above in connection with a particular exemplary aspect or embodiment can also be combined with other exemplary aspects and embodiments.

### BRIEF DESCRIPTION OF THE FIGURE

FIG. 1 shows a schematic illustration of a communication network.

### DETAILED DESCRIPTION

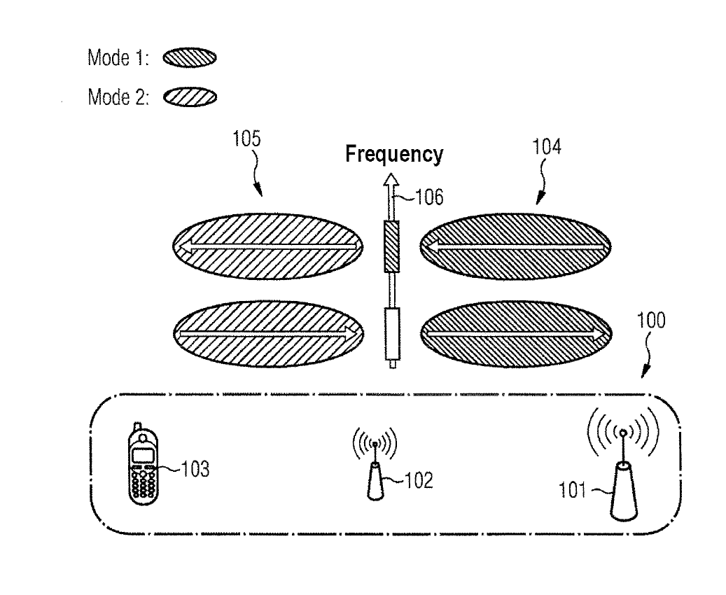

FIG. 1 shows a schematic illustration of a communication network 100. In FIG. 1, the communication network has a base station 101, a multihop forwarding node 102 and a terminal, e.g. a mobile telephone, 103. In reality, such a communication network has a multiplicity of base stations, forwarding nodes and terminals, which are not shown, however, in order to preserve the clarity in FIG. 1. In addition, FIG. 1 schematically indicates two modes, a first mode 104 and a second mode 105, wherein the first mode 104 corresponds to communication between the multihop forwarding node 102 and the terminal 103 and the second mode 105 corresponds to communication between the multihop forwarding node 102 and the base station 101. Each of these communications involves the use of two frequencies in an FDD network, as indicated schematically by the arrow 106. In this context, the multihop forwarding node 102 receives transmissions from the terminal on a first frequency, whereas signals or data packets from the multihop forwarding node 102 are sent to the terminal 103 on a second frequency. In the second mode, which relates to the communication of the multihop forwarding node 102 with the base station 101, the circumstances are exactly the reverse, i.e. the multihop forwarding node 102 sends on the first frequency and receives on the second frequency.

The text below briefly discusses the manner of operation of the communication network and particularly that of the multihop forwarding node 102. When the multihop forwarding node 102 is switched on, it is synchronized to the base station, for example by virtue of coarse synchronization first of all being performed using a channel synchronization signal SCH. Such coarse synchronization needs to be performed only when the multihop forwarding node 102 is switched on, whereas the progressive and fine synchronization can be performed by means of pilot signals. During the operation of the multihop forwarding node, constant synchronization is performed between the multihop forwarding node and the terminals by virtue of the multihop forwarding node sending on the synchronization signal itself to the terminals. This means that the multihop forwarding node should remain synchronized, even when it there is no reception taking place in particular frames or subframes.

By way of example, such synchronization signals SCH are transmitted in the LTE in subframes 1 and 6 (of 10), so that in these subframes the multihop forwarding node is in the transmission mode for the terminals. In the other eight subframes, the modes can be switched according to one of a plurality of options or patterns. That is to say that in these eight subframes the multihop forwarding node may be either in the aforementioned first mode 104 or second mode 105. In this case, the distribution of the modes over the subframes can be matched dynamically to the circumstances, for example to the volume of data, the network load or the channel qualities. This may involve the use of what is known as “Radio Source Management” (RRM). In particular, the change between reception mode and transmission mode can be matched or adapted to existing or planned selections. Such planned selections relate, by way of example, to time offsets between the frame starts for downlink and uplink communication in FDD networks.

An example of suitable signaling is:
Within the SCH subframe (first or sixth subframe), it is possible to provide information that a multihop forwarding node is present or active.
Changes in uses of the individual subframes, i.e. whether the multihop forwarding node is in the first mode 104 or the second mode 105 during a particular subframe, can be signaled by means of known radio resource management messages.
Alternatively, a control channel could also be used.

To improve the monitoring of the channel, e.g. performance of the channel (e.g. CFO tracking), the subframes in which the forwarding node was unavailable are omitted. These subframes are also omitted or skipped within the synchronous H-ARQ protocol. In addition, the scheduler of the base station should also be set up such that it sets or schedules a transmission to the forwarding node only when the forwarding node is in an appropriate mode, i.e. when it is ready to receive data packets from the base station (downlink base station forwarding node).

Such signaling may allow synchronous H-ARQ communication in conjunction with forwarding nodes which are able to maintain and use all of their flexibility for defining their frame structures, however. In addition, it may be possible to provide optimized synchronization algorithms, particularly in the case of intermittent transmission of synchronization signals or control channel signals by the forwarding node. In addition, such signaling and the use of such a forwarding node may also allow terminals which do not know this signaling or which do not know that a forwarding node is present to be supplied with signals by such an FDD forwarding node too, but this may result in a reduction in performance, since data packets, particularly also the ACK/NACK messages, can be lost.

The implementation of the invention is not limited to these instances of application and the system configurations mentioned further above but rather is similarly possible in a multiplicity of modifications which are within the scope of action in the art. In addition, it should be pointed out that reference symbols in the claims should not be regarded as limiting and that the terms “have” and “having” and similar terms do not exclude the presence of further elements or steps. Furthermore, listing as a plurality of means or elements does not exclude these means or elements from being able to be in the form of a single means or element.

### LIST OF REFERENCE SYMBOLS

100 Communication network
101 Base station
102 Forwarding node
103 Terminal
104 First mode
105 Second mode
106 Frequency

1. A multihop forwarding node for an FDD communication network, which has:
a node reception apparatus which is set up such that it can be used to receive signals from a terminal on a first frequency,
a node transmission apparatus which is set up such that it can be used to send signals on a second frequency to the terminal, and
a synchronization unit which is set up such that it can be used to send a synchronization signal to the terminal and/or a base station, so that the synchronization signal can be used to synchronize the multihop forwarding node to the base station and/or the terminal,
wherein the multihop forwarding node is set up such that it may be in a terminal mode, in which it can communicate with the terminal, or in a base station mode, in which it can communicate with the base station, and is also set up such that it can send an indicator signal to the terminal which indicates whether the multihop forwarding node can receive signals at a given time on the first frequency, and
wherein the indicator signal indicates which mode the multihop forwarding node is in.

2. The multihop forwarding node as claimed in claim 1, wherein the multihop forwarding node is set up such that in the terminal mode it can send signals to the terminal on the first frequency and can receive signals from the terminal on the second frequency, and such that in the base station mode it can send signals to a base station on the second frequency and can receive signals from the base station on the first frequency.

3. A terminal for an FDD communication network, which has:
a terminal reception apparatus which is set up such that it can be used to receive signals from a multihop forwarding node on a second frequency,
a terminal transmission apparatus which is set up such that it can be used to send signals on a first frequency to the multihop forwarding node, and
a control unit,
wherein the terminal is set up such that it can receive an indicator signal and a synchronization signal from the multihop forwarding node wherein the synchronization signal can be used to symphonize the terminal to the multihop forwarding node,
wherein the indicator signal indicates which mode from a terminal mode, in which it can communicate with the terminal, and a base station mode, in which it can communicate with the base station, the multihop forwarding node is in, and wherein the control unit is set up such that it controls a time for the sending of a request signal to the multihop forwarding node on the basis of the indicator signal.

4. The terminal as claimed in claim 3, wherein the request signal is an H-ARQ signal, particularly a synchronous H-ARQ signal.

5. The terminal as claimed in claim 4, wherein the control unit is set up such that the time determined for the sending of the request signal to the multihop forwarding node is a delayed time.

6. A method for the operation of a multihop forwarding node as claimed in claim 1 for an FDD communication network, wherein the method involves:
determining whether the multihop forwarding node is in a terminal mode, in which it can communicate with the terminal, or a base station mode, in which it can communicate with the base station, and
sending an indicator signal to a terminal, wherein the indicator signal is indicative of the determined mode.

7. A method for the operation of a terminal as claimed in claim 3 for an FDD communication network, wherein the method involves:
receiving an indicator signal in the terminal wherein the indicator signal indicates whether a multihop forwarding mode is in a terminal mode, in which it can communicate with the terminal, or a base station mode, in which it can communicate with the base station,
deciding when a request signal is sent to the multihop forwarding node, wherein the decision takes account of the indicator signal.

8. A program element which is set up such that, when executed on a processor, it controls a method as claimed in claim 6.

9. A computer-readable medium which stores a computer program, wherein the computer program is set up such that, when executed on a processor, it controls a method as claimed in claim 6.

10. A program element which is set up such that, when executed on a processor, it controls a method as claimed in claim 7.

11. A computer-readable medium which stores a computer program, wherein the computer program is set up such that, when executed on a processor, it controls a method as claimed in claim 7.
